(19) United States
(12) Patent Application Publication
(10) Pub. No.: US 2006/0294515 A1
(43) Pub. Date: Dec. 28, 2006

(54) Common operating system install method

(75) Inventors: David J. Gimpl, Rochester, MN (US); Cale T. Rath, Byron, MN (US); Tammy L. Van Hove, Elgin, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/165,388

(22) Filed: Jun. 23, 2005

(51) Int. Cl. G06F 9/445

(52) U.S. Cl. 717/174

(57) ABSTRACT

A method, apparatus, and article of manufacture for installing multiple, heterogeneous operating systems is provided. A network install manager is used to process network requests for various different operating system installs. The network install manager may be configured to provide an install kernel for a variety of operating systems to partitions defined for a logically partitioned system.

### BACKGROUND OF THE INVENTION

1. Field of the Invention

The present invention generally relates to methods for installing operating system software onto a computer.

2. Description of the Related Art

There are currently many different methods for installing an operating system onto a computer. For example, many distributions of the Linux® operating system may be installed using a CD-Rom install image. (Linux is a trademark of Linus Torvalds in the United States and other countries.) Alternatively, an install program may be used to connect to a network server and to download operating system components from the network server for installation on a local system. In either case, a user who desires to install an operating system must interact with the install mechanism to select the hardware settings, options, and software packages when installing an operating system. Many Linux® distributions are distributed with an installation program that allows a user to perform these tasks. Similarly, other operating systems are distributed with their own installation mechanisms. For example, AIX® and i5/OS®, both available from International Business Machines® of Armonk, N.Y., each have their own installation mechanisms, as do the Windows® series of operating systems distributed by Microsoft® Corp. of Redmond Wash. Typically, each individual operating system has its own install method (or methods).

Problems arise, however, when trying to install multiple, different operating systems onto a computer divided into a set of logical partitions. This is an especially difficult situation for manufacturing processes that build systems able to support logical system partitioning (e.g., IBM's POWER5 servers). In such an environment, there is no effective way to install multiple operating systems to a partitioned system in a converged manner. Instead, each partition acts as an independent computer system, and requires its own configuration parameters to be selected and an operating system to be installed, according to its install method. Thus, installation knowledge unique to each operating system must be maintained, and unique tools must be deployed to support the installation of multiple operating systems onto each partition of a partitioned computer.

The same problems arise when installing different operating systems onto multiple, individual computer systems. These difficulties are both time consuming and costly for the manufacturer who wishes to provide an operating system install mechanism to customers. Having a single installation mechanism for installing heterogeneous operating systems on multiple hardware systems, including logically partitioned systems would, therefore, reduce manufacturing cycle time and cost. Current install management applications, however, are configured to install only a single operating system, and none of these applications can currently handle installation requests for different operating systems.

Furthermore, operating systems are distributed under a wide variety of end-user licensing agreements. Oftentimes, this precludes the manufacturer of a system from installing an operating system because the end user must agree to the licensing terms under which the operating system is distributed before it may be installed onto a computer system. This problem is exacerbated on a partitioned system, where one physical collection of computer hardware may be divided into many logical partitions. Specifically, installation on a partitioned system requires the user to agree to multiple, different licensing agreements (i.e., one license for each operating system installed).

Because of these difficulties, the purchaser of a partitioned system is often required to install operating systems onto each partition individually. Similarly, an enterprise that wishes to manage the installation of multiple, heterogeneous operating systems to multiple computer systems must install operating systems individually, using the different install method for each particular operating system.

Accordingly, there remains a need for an operating system install method that allows multiple operating systems to be installed to different partitions of a partitioned system. There is also a need for an install method that is configured to install different operating systems using a common install method.

### SUMMARY OF THE INVENTION

The present invention generally provides a method, apparatus, and article of manufacture for installing multiple, heterogeneous operating systems to a variety of computer systems. One embodiment provides a method for processing a request to install an operating system onto a partition of a computer system. The method generally includes, receiving a request, communicated using a network boot protocol, that identifies the partition, retrieving a configuration profile for the partition that specifies the selected operating system, installation parameters, and software applications to be installed, and transmitting an install image to the partition, corresponding to the configuration profile.

Another embodiment provides a method for installing a selected operating system onto a partition of a computer system. The method generally includes booting the partition using a network boot protocol, and establishing a connection with a network install manager. The method generally further includes, retrieving a kernel image corresponding to the selected operating system and an install profile defined for the partition; and executing the install kernel, wherein the install kernel is configured to retrieve a common install source for the operating system, configured according to the install profile.

Another embodiment provided a computer-readable medium containing a program configured to process a request to install an operating system onto a partition of a computer system. The program is generally configured to (i) retrieve a request, communicated using a network boot protocol, that identifies the computer system; retrieve a configuration profile for the partition that specifies the selected operating system, installation parameters, and software applications to be installed, and (iii) to transmit an install image to the computer system, corresponding to the configuration profile.

Another embodiment provides a system for installing one of a plurality of operating systems onto a partition of a computer system. The system generally includes a hardware management application configured to define computing resources assigned to the partition and to generate a configuration profile specifying a selected operating system, installation parameters, and software applications to be installed onto the partition. The system generally further includes, a network install manager configured to (i) store common install sources for the plurality of operating systems, (ii) receive a request from the partition, communicated using a network boot protocol, and (iii) in response, to retrieve the configuration profile associated with the partition, and (iv) transmit the selected operating system install source for the selected operating system to the partition, configured according to the install profile.

### BRIEF DESCRIPTION OF THE DRAWINGS

So that the manner in which the above recited features of the invention can be understood, a more particular description of the invention, briefly summarized above, may be had by reference to the exemplary embodiments illustrated in the appended drawings. Note, however, that the appended drawings illustrate only typical embodiments of this invention and should not, therefore, be considered limiting of its scope, for the invention may admit to other equally effective embodiments.

FIG. 1 illustrates a network install manager interacting with a plurality of computer systems and components, according to one embodiment of the invention.

FIG. 2 illustrates a hardware management console application for configuring a computer system by dividing available hardware resources into a plurality of logical partitions, according to one embodiment of the invention.

FIG. 3 illustrates a logically partitioned computer system that includes a plurality operating systems installed onto the partitions, according to one embodiment of the invention.

FIG. 4 illustrates a network install manager configured to process an operating system install requests made by a plurality of computer systems, according to one embodiment of the invention.

FIG. 5 illustrates a method for creating an install source for a given operating system, according to one embodiment of the invention.

FIG. 6 illustrates a method for configuring a partition on a logically partitioned system, according to one embodiment of the invention.

FIG. 7 illustrates a method for performing an operating system installation, according to one embodiment of the invention.

### DETAILED DESCRIPTION OF THE PREFERRED EMBODIMENTS

Embodiments of the invention provide a method, apparatus, and article of manufacture for managing the installation of multiple, heterogeneous operating systems using a common install method. In one embodiment, a network install manager responds to requests to install an operating system onto a newly defined partition. The partition may be one of multiple partitions created for a single system, or a partition that includes an entire system. The network install manager identifies the system making the request and provides the operating system to the requesting machine for installation. In one embodiment, the installation parameters and software packages for the selected operating system (e.g., hardware settings, drivers, operating system components, end-user applications, and the like) are specified by a user when the user creates a new partition.

Once the newly created partition is activated (e.g., when the computer system that includes the partition is booted), the partition may be configured to connect to the network install manager and identify itself. For example, the partition may employ known network boot protocols such as bootp or PXE to establish a connection with the network install manager. As those skilled in the art will recognize, the bootp and PXE protocols allow a system to boot a computer system (or partition) without using any local storage (other than memory), by connecting to a network and retrieving an operating system install kernel. The install kernel is loaded by the partition, and then executed to retrieve the install source for the selected operating system.

The network install manager identifies the partition making a connection request, and retrieves the configuration profile associated with the identified partition. In one embodiment, the configuration profile identifies the operating system, installation parameters, and software applications that should be provided by the install manager. Once the correct configuration profile for the partition is retrieved, the newly created partition downloads and installs the operating system (and other software packages) without the need for any further intervention by a user. Except, however, during this process a user may be presented with an end user license agreement governing the use of the operating system selected for the partition. In this case, the user may be required to agree with the terms of the end user license agreement (e.g., by selecting an “I agree” checkbox or clicking on a button labeled “I agree”) before the operating system is installed onto the partition. Alternatively, the user may have previously agreed to the terms of a given license agreement, thereby avoiding the need of the user to individually agree to the individual license agreements upon downloading a respective operating system. In this regard, it is contemplated that the user may have previously agreed to specific license agreements, or specific, standardized licensing terms typically found in licensing agreements.

The following description references embodiments of the invention. The invention, however, is not limited to any specifically described embodiment; rather, any combination of the following features and elements, whether related to a described embodiment or not, implements and practices the invention. Moreover, in various embodiments the invention provides numerous advantages over the prior art. Although embodiments of the invention may achieve advantages over other possible solutions and the prior art, whether a particular advantage is achieved by a given embodiment does not limit the scope of the invention. Thus, the following aspects, features, embodiments and advantages are illustrative of the invention and are not considered elements or limitations of the appended claims; except where explicitly recited in a claim. Similarly, references to “the invention” should neither be construed as a generalization of any inventive subject matter disclosed herein nor considered an element or limitation of the appended claims, except where explicitly recited in a claim.

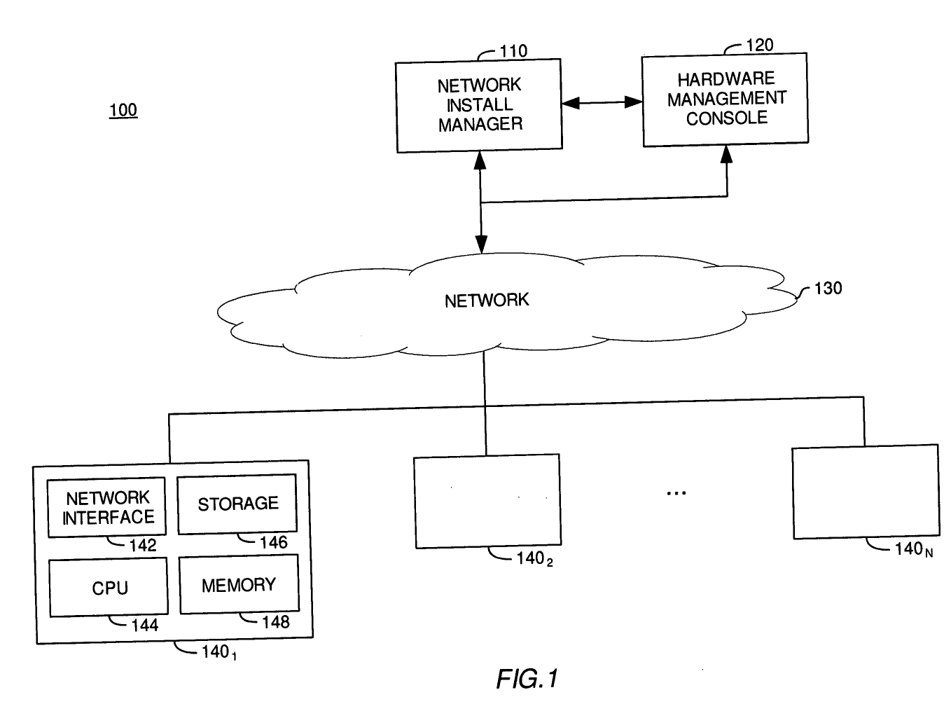

One embodiment of the invention is implemented as a program product for use with a computer system such as, for example, the computer system 100 shown in FIG. 1 and described below. The program product defines functions of the embodiments (including the methods) described herein and can be contained on a variety of signal-bearing media. Illustrative signal-bearing media include, without limitation, (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed across communications media, (e.g., a computer or telephone network) including wireless communications. The latter embodiment specifically includes information shared over the Internet or other computer networks. Such signal-bearing media, when carrying computer-readable instructions that perform methods of the invention, represent embodiments of the present invention.

In general, software routines implementing embodiments of the invention may be part of an operating system or part of a specific application, component, program, module, object, or sequence of instructions such as an executable script. Such software routines typically comprise a plurality of instructions capable of being performed using a computer system. Also, programs typically include variables and data structures that reside in memory or on storage devices as part of their operation. In addition, various programs described herein may be identified based upon the application for which they are implemented. Those skilled in the art recognize, however, that any particular nomenclature or specific application that follows facilitates a description of the invention and does not limit the invention for use solely with a specific application or nomenclature. Furthermore, application programs are described herein using discrete modules or components interacting with one another. Those skilled in the art recognize, however, that different embodiments may combine or merge such components and modules in many different ways.

FIG. 1 illustrates a computing environment that includes a hardware management console 110 interacting with a plurality of computer systems 140_{1-N}, according to one embodiment of the invention. In one embodiment, the hardware management console 110 is used to select the hardware, operating system, and software configuration for each partition created using computer systems 140_{1-N}. Accordingly, the hardware management console 110 may itself be a computer system configured with application software that allows a user to specify what hardware, operating system(s), and end user software will be installed on each of computer system 140_{1-N}. Once the parameters and partitions are specified for a computer system 140, the hardware management console 120 may provide the network install manager 110 with a configuration profile for the partition. In one embodiment, the configuration profile may be associated with the partition using a unique identifier such as a MAC address of a network interface assigned to the partition. Subsequently, when the system 140 is booted, it may be configured to connect to the network install manager 110 using a network boot protocol to obtain the components required to install the selected operating system.

Illustratively, system 140₁ is shown configured with central processing unit (CPU) 144, storage 146, memory 148 and network interface 142. After being configured, when booted, the system 140 may be configured to connect to network 130 and request an operating system install kernel. Systems 140_{2-N} may be similarly specified by a collection of computer hardware components.

In one embodiment, the network install manager 110 acts as server for the systems 140_{1-N} (which act as a client). As those skilled in the art will recognize, typically a server system is a computer that provides resources (in this case, the files and programs required for installation) to another computer system. A system that is dependent on such a server is referred to as a client. Using this terminology, any computer system that receives resources from the network install manager 110 is a client, although the same machine (receiving services from network install manager 110) can also be a server (i.e. it may provide services to other clients) in an overall network environment. For example, the partitions of system 140 may be configured to act as network servers, once the operating system and application software is loaded. The network install manager 110 may be configured to install an operating system onto a single footprint server (i.e., a system with a single partition), as well as multiple operating systems for a set of logical partitions created for a particular system.

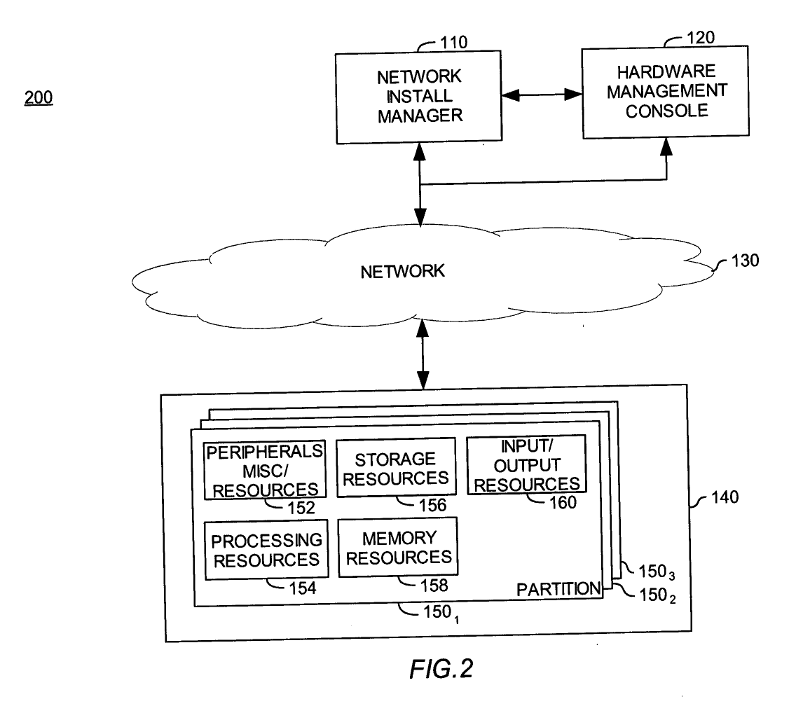

As part of creating a partition for a system, a user may assign both dedicated and shared resources to a partition, and also specify what operating system, configuration settings, and application packages should be installed on the system. For example, FIG. 2 illustrates the hardware management console 120 interacting with one of systems 140. By way of example, system 140 includes multiple partitions (150₁₋₃). Alternatively, a system may include only a single partition (e.g., standalone workstation).

The hardware management console allows a user to carve up the resources available to a computer system 140 among a plurality of individual partitions. Resources divided in this manner may be either dedicated (i.e., assigned to a single partition) or shared (i.e., available for use by multiple partitions). Illustratively, partition 150₁ includes storage resources (e.g., hard drive partitions), memory (e.g., DRAM), processing resources, I/O resources (e.g., network interfaces), and peripherals/miscellaneous resources. Essentially any hardware, or resource that may be assigned to or consumed by a computer system 140, may be assigned to a partition 150. In addition to configuring the hardware resources assigned to a partition, the management console 120 may be configured to select an operating system and associated parameters for a given partition. For example, if a user desires to install a Linux® distribution onto the partition, then the user may specify the user accounts, root password, network parameters, and software applications, corresponding to the Linux® distribution, to also install onto the partition.

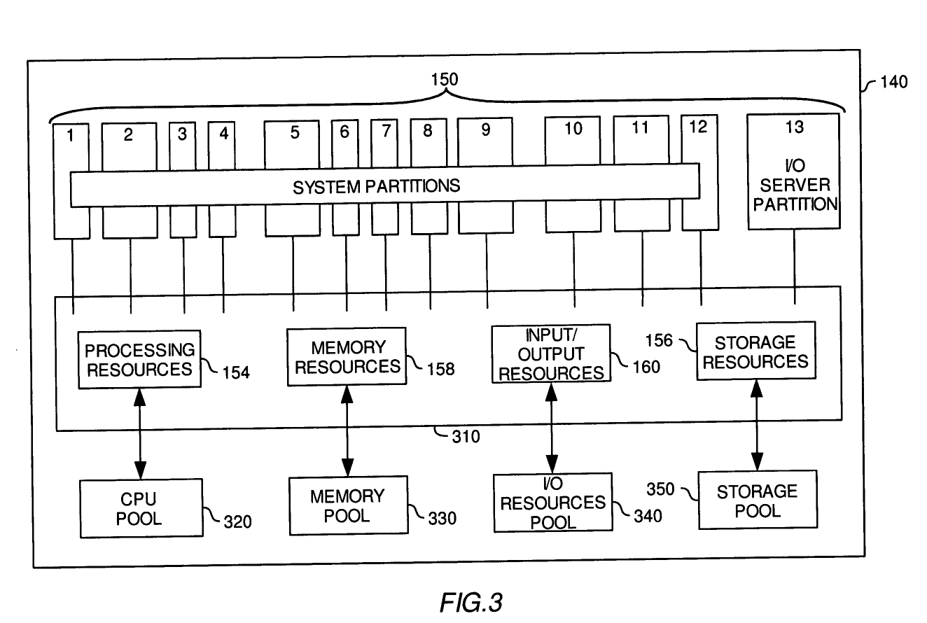

After a given partition is configured, and has an operating system installed, according to the present invention, the partition acts as an independent computer system, transparent to any other partitions running on the same underlying hardware. For example, FIG. 3 is a functional block diagram of a fully configured system 140, configured using a network install manager 110, according to one embodiment of the invention. Illustratively, the configured system 140 includes multiple system partitions (150₁₋₁₂). Additionally, I/O server partition 150₁₃ provides management services for the user level partitions 150₁₋₁₂. Resources 310 illustrate the resources provided by the hardware of the system 140, divided among the partitions 145. The resources available to each partition are defined during system configuration using hardware management console 120. In one embodiment, the resources may include both dedicated and shared resources. As illustrated, the partitioned resources includes processing resources (provided by processor pool 320), memory resources (provided by memory pool 330) and I/O resources (provided by I/O resources pool 340), and storage resources (provided by storage pool 350). Although FIG. 3 illustrates multiple partitions for a single computer system, embodiments where the hardware management console 120 is used to define a single partition for a given system is also contemplated.

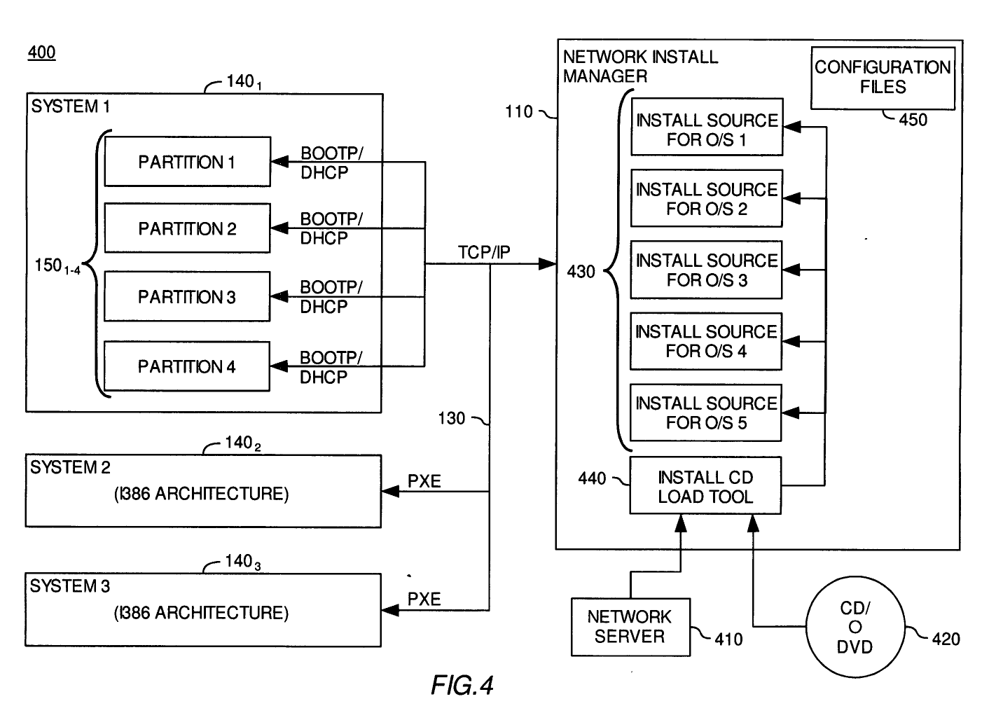

As described above, once a partition is configured using the hardware management console 120, the partition is ready for an operating system (and selected software applications) to be installed. FIG. 4 illustrates three systems 140₁₋₃ communicating with network install manager 110 to install a variety of heterogeneous operating systems, according to one embodiment of the invention. Illustratively, system one is an IBM Power5 server configured with create four individual partitions using hardware management console 120 (Partitions 1 through 4, each including a selected operating system 1 through 4, respectively. Systems 2 and 3 illustrate computer systems configured each as a single partition.

As described above, the hardware management console 120 allows users to create and define each of these partitions as a collection of hardware resources, a selected operating system, configuration settings, and application software. Once created, the actual operating system is installed over network 130 using network install manager 110.

In one embodiment, each individual partition communicates with the network install manager 110 using a collection of network-based services (e.g., NFS, TFTP, BOOTP, PXE, DHCP, and other network-based boot protocols whether known or later developed). As illustrated, the partitions 150₁₋₄ of system 1 (140₁) communicate with the network install manager 110 using bootp and dhcp network protocols and systems 2 and 3 communicate with the network install manager 110 using the PXE protocol. As those skilled in the art will recognize, bootp is short for “bootstrap protocol,” and is a network protocol that allows a system to obtain a boot image from a an IP address. Similarly, PXE (short for Preboot eXecution Environment) is a specification published by Intel® corporation of Santa Clara, Calif., which provides an environment to bootstrap a system using a network interface independent from any available storage device (other than memory).

Using the boot protocol, a given partition creates a connection with the network install manager 110 during booting. In turn, the network install manager identifies the system, selects the correct install source 430 and configuration file 450, and provides the system with the appropriate install kernel. For example, the network install manager 110 may provide partition 4 of system 1 with an appropriate install kernel for the selected operating system specified in its configuration profile. Similarly, the other illustrated partitions each receive the correct install kernel when booted. After receiving the install kernel, partition 4 of system 1 loads the install kernel, which proceeds to install the selected operating system partition 4, using the settings provided by configuration file 450.

In one embodiment, each partition may be identified by the network install manager 110 using a network identifier. For example, during system partitioning, each partition may be assigned network resources such as a network interface identified by a unique MAC address. When booted, a partition establishes a network connection with the network install manager 110 and provides its assigned MAC address to the network install manager 110. In response, the network install manager 140 retrieves the system configuration 450 associated with the identifier, and provides the install source for the operating system to the partition. For example, the install manager may provide an appropriate boot kernel to the partition configured to retrieve and install the full operating system as specified by configuration 450.

Using the network install manager, an operating system may be installed to a group of computer systems with a common configuration or a customized version of an operating system may be installed to meet the specific needs of a given system or user. The number of systems that may have an operating system installed simultaneously depends upon the throughput of the network 130, among other factors.

In one embodiment, the install source for each operating system stored by the network install manager 110 is provided by operating system install sources 420 and 430. Illustratively, network install manager 110 includes install sources for five different operating system install sources. Each operating system may be loaded into the network install manager using install CD load tool 440. The load tool 440 is used to create a version of the operating system and its install mechanism in a common format. For example, most operating systems are distributed using optical media (e.g., a CD- or DVD-ROM). The CD load tool 440 may be configured to read this media and transfer a copy of the operating system installation from the optical media 420 to the network install manager 110. Alternatively, CD load tool 440 may be configured to retrieve some operating systems from a network server 410.

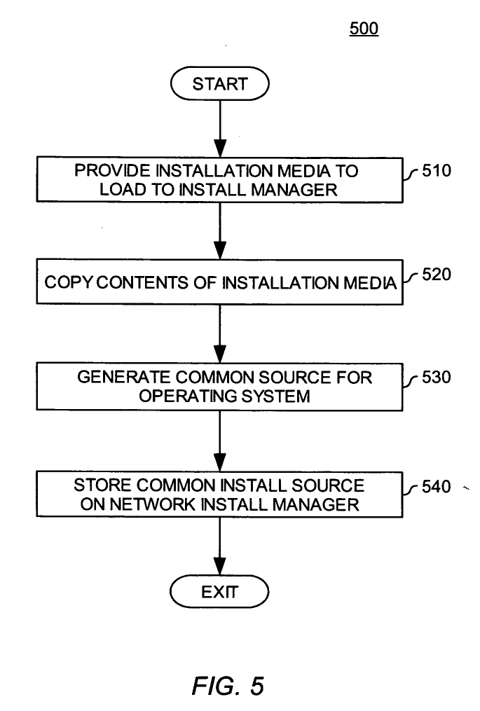

FIG. 5 illustrates a method 500 for creating an install source 430 for a given operating system, according to one embodiment of the invention. The method 500 begins at step 510 where the installation media is made available to the network install manager 110. For example, the network install manager may read the install source stored on a CD- or DVD-ROM. At step 520, a copy of the install source is made by the network install manager 510. At step 530, a common form of the installation parameters associated with a given operating system is defined. For example, each operating system setup typically allows a user to configure an installation through a variety of parameters. The common form allows a user to configure these parameters, for any of the operating systems available on network install manager 110 using a common interface.

At step 540, the common install source is stored on network install manager 110. After completing the steps of method 500, the network install manger is configured to serve an install kernel of the particular operating system to a requesting client. This process is repeated for each operating system that is to be made available through the network install manager 110.

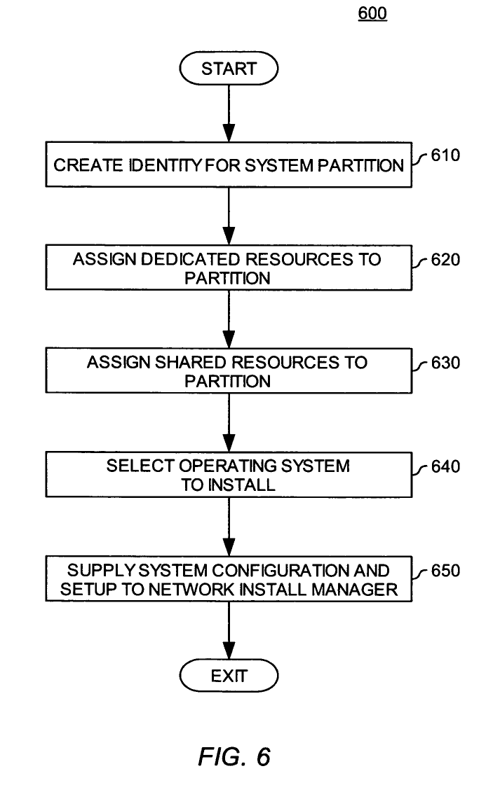

FIG. 6 illustrates a method 600 for creating a logical partition of a computer system, according to one embodiment of the invention. The method 600 begins at step 600 where a user creates an identifier for a new system partition. In one embodiment, a user interacts with the hardware management console 120 to create a new partition. At step 620 dedicated resources are assigned to the partition, and at step 630, shared resources are assigned to the partition. As described above, in conjunction with FIG. 2, any available resources of the underlying computer system may be assigned to a partition as either a dedicated or shared resource.

At step 640, the operating system for the partition is selected. For example, a user may elect to install any number of operating systems that are compatible with the resources assigned to the partition at steps 620 and 630. At step 650 the system configuration parameters are defined. For example, a user may select which components of the operating system should be installed, along with any software packages or end user applications (and configuration settings) for the partition. This information may be stored in a configuration profile 450 associated with the partition. In one embodiment, the configuration file may be composed using the eXtensible Markup Language, although other markup languages or representations of the configuration profile 450 may also be used.

In one embodiment, the configuration profile is associated with the network resources (e.g., a MAC address) assigned to the system. This allows the network install manager to respond to a boot request (e.g., a request generated by a new partition using the bootp or PXE protocols) with the correct configuration profile and install source. After the partition is configured, and the configuration profile 450 is stored by the network install manager 110, the method completes. In one embodiment, where a user configures multiple partitions for a single system, then steps 610-650 may be repeated to allow a user to create each such logical partition.

For example, the partitions for a given a computer system may be configured by a customer interacting with the hardware management console 120. Alternatively, within a single enterprise, a network install manager 110 may be used to configure many different systems for use by individuals of the enterprise. Regardless, once configured (e.g., through the method of FIG. 6), each partition requires the selected operating system (and associated application software) to be installed.

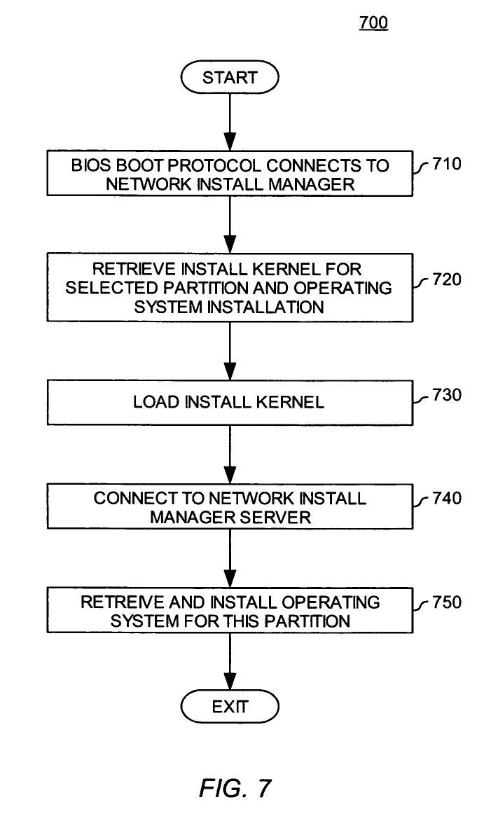

FIG. 7 illustrates a method 700 for installing an operating system on a configured partition, according to one embodiment of the invention. The method begins at step 710, wherein the system (or logical partition, on a system with multiple partitions) without an operating system is booted. The boot process typically refers to the components that begin initializing a computer's operating system from data stored in the BIOS of a partition. In one embodiment, the system is booted using the bootp or PXE protocols to communicate with network install manager 110.

At step 720, the network install manager 110 receives a request for an operating system install kernel. In one embodiment, the network install manager 110 identifies the system and retrieves the correct configuration profile of the requesting partition. For example, the system may be identified using the MAC address assigned to the particular partition that is stored in the corresponding configuration profile 450. After identifying which partition is involved, the network install manager provides the install kernel to the requesting partition. In one embodiment, the install kernel may be configured to provide the partition with the minimum functionality required to perform a full installation of the operating system selected for the partition. At step 730, the install kernel is loaded into the memory of the requesting partition and begins executing.

At step 740, once the install kernel is loaded and running, it creates a connection with the network install manager 110 and retrieves the installation source for the operating system selected for the current partition. At step 750, the installation source for the partition is used to install the full operating system onto the currently selected partition. If the system being configured includes multiple partitions, then the steps of method 700 are repeated for each additional partition. Optionally, during the process of installation, an end user may be required to agree with the terms of an end user licensing agreement associated with a selected operating system, and/or with any of the application software associated with the partition. In a particular embodiment, acceptance of the licensing agreement may occur during installation of the full operating system using the install kernel. Known methods such as requiring a user to check an “I agree” button, or to input unique license strings or license keys may be used.

Once the method 700 is completed, the partition may be booted using the installed operating system, and put into production for its intended use. As described herein, embodiments of the present invention may allow a purchaser of a computer system to define and configure multiple partitions, each with a selected operating system. Subsequently, when a partition of the computer system is booted, it connects to the network install manager to retrieve and install the selected operating system. In one embodiment, access to the hardware management console and network install manager may be provided for a service fee. For example, various fee structures might allow users to install different operating systems onto the partitions of a computer system using a single-use fee, flat fee, subscription fee, per operating system fee, or other fee arrangement appropriate to the situation.

### CONCLUSION

Embodiments of the invention allow users to configure the hardware, operating system, and software used for a computer system. In one embodiment, each computer system may be carved into multiple logical partitions, each running a different operating system. As each partition is created, a corresponding configuration profile (e.g., specific to the respective partitions) is saved by a network install manager. Each newly defined partition may be configured to connect to a network install manager using a network boot protocol. The network install manager stores the installation source for a plurality of operating systems. After identifying a request to install an operating system, the network install manager identifies the system making the request and, using the configuration profile for the particular partition, provides an install kernel for the particular partition. The install kernel itself is configured to retrieve and install the full operating system install image from the network install manager.

Once the install kernel for a given partition is loaded and running, the operating system source may then be transmitted over a network to the system and used to install the full operating system onto the partition. In this way, multiple, heterogeneous operating systems may be installed, without requiring an end user to install each one on each partition individually. Further, because many operating systems are distributed under a licensing agreement, this install technique allows the end user to accept the license terms associated with each different operating system as it is installed onto a given partition.

While the foregoing is directed to embodiments of the present invention, other and further embodiments of the invention may be devised without departing from the basic scope thereof, and the scope thereof is determined by the claims that follow.

What is claimed is:

1. A method for processing a request to install an operating system onto a partition of a computer system, comprising:
receiving a request that identifies the partition;
retrieving a configuration profile for the partition that specifies the selected operating system; and
transmitting an operating system install image to the partition, corresponding to the configuration profile.

2. The method of claim 1, wherein the configuration profile further specifies a set of installation parameters for the selected operating system.

3. The method of claim 1, wherein the request is communicated using a network boot protocol.

4. The method of claim 1, wherein the configuration profile is predefined for the partition using a hardware management console.

5. The method of claim 1, wherein the partition comprises one of a plurality of partitions defined for the computer system.

6. The method of claim 1, wherein the configuration profile specifies at least one computing resource shared between at least some of the plurality of partitions.

7. The method of claim 1, wherein the partition is identified by a network install manager using a MAC address associated with the partition.

8. The method of claim 1, wherein the operating system install image is selected from a plurality of operating system install images, stored on a network install manager.

9. The method of claim 8, further comprising, providing access to the network install manager as a fee-based service, and processing the request to install the operating system onto the partition, in exchange for the payment of a fee.

10. The method of claim 1, wherein the install image requires an end-user to agree to the terms of an end-user license agreement, prior to installing the operating system onto the partition.

11. The method of claim 1, wherein transmitting the operating system install image to the partition comprises, transmitting an install kernel to the partition, wherein install kernel is configured to boot the partition and retrieve the operating system install image.

12. A method for installing a selected operating system onto a partition of a computer system, comprising:
booting the partition using a network boot protocol;
establishing a connection with a network install manager;
retrieving an install kernel image, corresponding to the selected operating system; and
executing the install kernel, wherein the install kernel is configured to retrieve and install the selected operating system, configured according to a pre-defined install profile.

13. The method of claim 12, wherein the pre-defined install profile specifies at least one computing resource shared between at least some of the plurality of partitions.

14. A computer-readable medium containing a program, which when executed on a computer system performs an operation for processing a request to install an operating system onto a partition of a computer system, comprising:
receiving a request that identifies the partition;
retrieving a configuration profile for the partition that specifies the selected operating system; and
transmitting an operating system install image to the partition, corresponding to the configuration profile.

15. The method of claim 14, wherein the configuration profile is predefined for the partition using a hardware management console.

16. The computer-readable medium of claim 14, wherein the configuration profile further specifies a set of installation parameters for the selected operating system.

17. The computer-readable medium of claim 14, wherein the request is communicated using a network boot protocol.

18. The computer-readable medium of claim 14, wherein the partition comprises one of a plurality of partitions defined for the computer system.

19. The computer-readable medium of claim 14, wherein the configuration profile specifies at least one computing resource shared between at least some of the plurality of partitions.

20. The computer-readable medium of claim 14, wherein the operating system install image is selected from a plurality of operating system install images, stored on a network install manager.

21. The computer-readable medium of claim 14, wherein the network boot protocol is selected from one of the bootp protocol and the PXE protocol.

22. A system for installing one of a plurality of operating systems onto a partition of a computer system, comprising:
a hardware management application configured to define computing resources assigned to the partition and to generate a configuration profile specifying a selected operating system, installation parameters, and software applications to be installed onto the partition; and
a network install manager configured to (i) store install images for the plurality of operating systems, (ii) to receive a request from the partition, communicated using a network boot protocol, and (iii) in response, to retrieve the configuration profile associated with the partition, and (iv) to transmit the selected operating system install source for the selected operating system to the partition, configured according to the install profile.

23. The system of claim 22, wherein the partition comprises one of a plurality of partitions created for the computer system.
